(19) United States
(12) Patent Application Publication
(10) Pub. No.: US 2024/0241728 A1
(43) Pub. Date: Jul. 18, 2024

(54) HOST AND DPU COORDINATION FOR DPU MAINTENANCE EVENTS

(71) Applicant: VMware, Inc., Palo Alto, CA (US)

(72) Inventors: Sowgandh Sunil Gadi, San Jose, CA (US); Venkata Subhash Reddy Peddamallu, Sugar Hill, CA (US); Andrei Evgenievich Warkentin, South Elgin, IL (US)

(21) Appl. No.: 18/097,601

(22) Filed: Jan. 17, 2023

(51) Int. Cl. G06F 9/4401

(52) U.S. Cl. CPC G06F 9/4403

(57) ABSTRACT

Disclosed are various examples of host and data processing unit (DPU) coordination for DPU maintenance events. A host device can have a DPU device connected to it. A data processing unit (DPU) maintenance process executed by a host device can quiesce applications or virtual machines of the host device, and call a DPU isolation interface that isolates the DPU device to prevent host panic. A kernel process of the host device unloads a driver of the DPU device from the host device and removes the DPU device from a device manager of the host device. A DPU maintenance action is performed once the DPU device is isolated.

### BACKGROUND

Management Enterprises can employ a management service that uses virtualization to provide the enterprise with access to software, data, and other resources. The management service use host devices to execute workloads that provide software services for enterprise activities. The enterprises can use other host devices to access these workloads.

Data processing units (DPUs) can be physically installed to the various host devices. These DPUs can include processors, a network interface, and in many cases can include acceleration engines capable of machine learning, networking, storage, and artificial intelligence processing. The DPUs can include processing, networking, storage, and accelerator hardware. However, DPUs can be made by a wide variety of manufacturers. The interface and general operations can differ from DPU to DPU.

This can pose problems for management services and enterprises that desire to fully utilize the capabilities of DPUs in host devices. There is a need for better mechanisms that can integrate DPUs into a virtualization and management solution.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment that includes components that provides host and data processing unit (DPU) coordination for DPU maintenance events, according to the present disclosure.

FIG. 2 is a sequence diagram that provides an example of the operation of components of the networked environment of FIG. 1, according to the present disclosure.

FIG. 3 is a sequence diagram that provides another example of the operation of components of the networked environment of FIG. 1, according to the present disclosure.

FIG. 4 is a sequence diagram that provides another example of the operation of components of the networked environment of FIG. 1, according to the present disclosure.

### DETAILED DESCRIPTION

The present disclosure relates to providing host and data processing unit (DPU) coordination for DPU maintenance events. These maintenance events can include DPU shutdowns, host shutdowns, DPU firmware installations, DPU OS installations, and other DPU instruction installations. Typically, when a DPU such as a SmartNIC is reset or rebooted, this can cause a surprise link down error or a PCIe uncorrectable error. The error can panic a component of the host device to which the DPU is connected, such as a host operating system kernel or another software component. The relevant host operating system drivers, input output (IO) stack and applications may crash as well. A DPU device can reset or reboot in a number of scenarios, including planned DPU maintenance scenarios. However, existing technologies do not coordinate DPU maintenance events with the host device to which a DPU device is connected. However, the present disclosure provides mechanisms that can prevent host panics by isolation of the DPU prior to performing a maintenance event. Isolation of the DPU device can include quiescing (e.g., pausing, suspending, or halting) applications and virtual machines, disconnecting a downstream PCI port to which the DPU device is connected, unloading DPU drivers from the host device, among other actions. The DPU maintenance activity can take several minutes or longer, and can include a number of DPU reboots. Once the DPU maintenance activity completes, the DPU device can be brought back online and reintegrated with to the host including re-enumeration of the DPU device, loading drivers and continuing to offer services to applications. In some examples, applications that have been quiesced to prevent accessing the DPU can be reactivated or unquiesced.

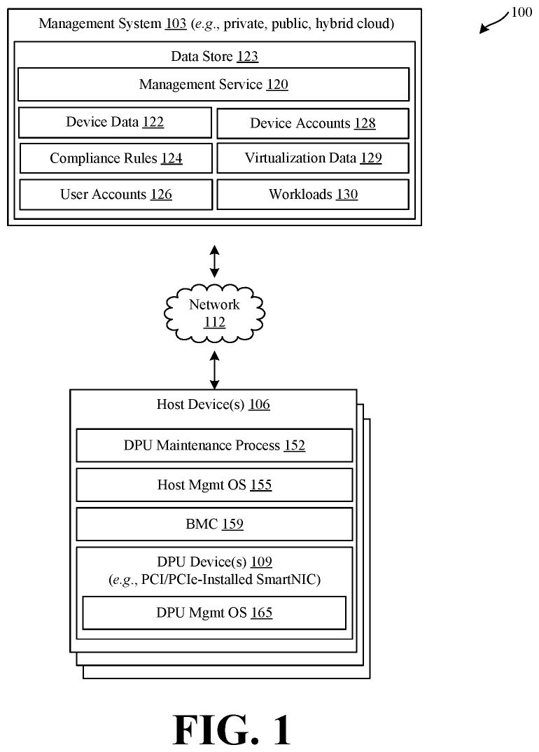

With reference to FIG. 1, shown is an example of a networked environment 100. The networked environment 100 can include a management system 103, host devices 106, and other components in communication with one another over a network 112. DPU devices 109 can be installed to the host devices 106. In some cases, host devices 106 can include computing devices or server computing devices of a private cloud, public cloud, hybrid cloud, and multi-cloud infrastructures. Hybrid cloud infrastructures can include public and private host computing devices. Multi-cloud infrastructures can include multiple different computing platforms from one or more service providers in order to perform a vast array of enterprise tasks.

The host devices 106 can also include devices that can connect to the network 112 directly or through an edge device or gateway. The components of the networked environment 100 can be utilized to provide virtualization solutions for an enterprise. The hardware of the host devices 106 can include physical memory, physical processors, physical data storage, and physical network resources that can be utilized by virtual machines. Host devices 106 can also include peripheral components such as the DPU devices 109. The host devices 106 can include physical memory, physical processors, physical data storage, and physical network resources. Virtual memory, virtual processors, virtual data storage, and virtual network resources of a virtual machine can be mapped to physical memory, physical processors, physical data storage, and physical network resources of the host devices 106. The host management operating system 155 can provide access to the physical memory, physical processors, physical data storage, and physical network resources of the host devices 106 to perform workloads 130.

The host management operating system 155 can provide access to the physical memory, physical processors, physical data storage, and physical network resources of the host devices 106 to perform workloads 130. The host management operating system 155 can include a number of software components that work in concert for management of the host device 106. The components of the host management operating system 155 can include a bootloader, a host management kernel component, and a host management hypervisor, among other components. An example of the host management operating system 155 can include VMWARE ESXI®. The host management kernel can provide a number of functionalities, including a kernel-to-kernel communications channel along with the DPU management kernel of the DPU management OS 165.

The DPU devices 109 can include networking accelerator devices, smart network interface cards, or other cards that are installed as a peripheral component. The DPU devices 109 themselves can also include physical memory, physical processors, physical data storage, and physical network resources. The DPU devices 109 can also include specialized physical hardware that includes accelerator engines for machine learning, networking, storage, and artificial intelligence processing. Virtual memory, virtual processors, virtual data storage, and virtual network resources of a virtual machine can be mapped to physical memory, physical processors, physical data storage, physical network resources, and physical accelerator resources of the DPU devices 109.

The DPU management operating system 165 can communicate with the host management operating system 155 and/or with the management service 120 directly to provide access to the physical memory, physical processors, physical data storage, physical network resources, and physical accelerator resources of the DPU devices 109. The components of the DPU management operating system 165 can include a bootloader, a DPU management kernel, and a number of other operating system functionalities, among other components. An example of the DPU management operating system 165 can include VMWARE ESXIO®.

Virtual devices including virtual machines, containers, and other virtualization components can be used to execute the workloads 130. The workloads 130 can be managed by the management service 120 for an enterprise that employs the management service 120. Some workloads 130 can be initiated and accessed by enterprise users through client devices. The virtualization data 129 can include a record of the virtual devices, as well as the host devices 106 and DPU devices 109 that are mapped to the virtual devices. The virtualization data 129 can also include a record of the workloads 130 that are executed by the virtual devices.

The network 112 can include the Internet, intranets, extranets, wide area networks (WANs), local area networks (LANs), wired networks, wireless networks, other suitable networks, or any combination of two or more such networks. The networks can include satellite networks, cable networks, Ethernet networks, telephony networks, and other types of networks.

The management system 103 can include one or more host or server computers, and any other system providing computing capability. In some examples, a subset of the host devices 106 can provide the hardware for the management system 103. While referred to in the singular, the management system 103 can include a plurality of computing devices that are arranged in one or more server banks, computer banks, or other arrangements. The management system 103 can include a grid computing resource or any other distributed computing arrangement. The management system 103 can be multi-tenant, providing virtualization and management of workloads 130 for multiple different enterprises. Alternatively, the management system 103 can be customer or enterprise-specific.

The computing devices of the management system 103 can be located in a single installation or can be distributed among many different geographical locations which can be local and/or remote from the other components. The management system 103 can also include or be operated as one or more virtualized computer instances. For purposes of convenience, the management system 103 is referred to herein in the singular. Even though the management system 103 is referred to in the singular, it is understood that a plurality of management systems 103 can be employed in the various arrangements as described above.

The components executed on the management system 103 can include a management service 120, as well as other applications, services, processes, systems, engines, or functionality not discussed in detail herein. The management service 120 can be stored in the data store 123 of the management system 103. While referred to generally as the management service 120 herein, the various functionalities and operations discussed can be provided using a management service 120 that includes a scheduling service and a number of software components that operate in concert to provide compute, memory, network, and data storage for enterprise workloads and data. The management service 120 can also provide access to the enterprise workloads and data executed by the host devices 106 and can be accessed using client devices that can be enrolled in association with a user account 126 and related credentials.

The management service 120 can communicate with associated management instructions executed by host devices 106, client devices, edge devices, and IoT devices to ensure that these devices comply with their respective compliance rules 124, whether the specific host device 106 is used for computational or access purposes. If the host devices 106 or client devices fail to comply with the compliance rules 124, the respective management instructions can perform remedial actions including discontinuing access to and processing of workloads 130.

The data store 123 can include any storage device or medium that can contain, store, or maintain the instructions, logic, or applications described herein for use by or in connection with the instruction execution system. The data store 123 can be a hard drive or disk of a host, server computer, or any other system providing storage capability. While referred to in the singular, the data store 123 can include a plurality of storage devices that are arranged in one or more hosts, server banks, computer banks, or other arrangements. The data store 123 can include any one of many physical media, such as magnetic, optical, or semiconductor media. More specific examples include solid-state drives or flash drives. The data store 123 can include a data store 123 of the management system 103, mass storage resources of the management system 103, or any other storage resources on which data can be stored by the management system 103. The data store 123 can also include memories such as RAM used by the management system 103. The RAM can include static RAM (SRAM), dynamic RAM (DRAM), synchronous DRAM (SDRAM), and other types of RAM.

The data stored in the data store 123 can include management data including device data 122, enterprise data, compliance rules 124, user accounts 126, and device accounts 128, as well as other data. Device data 122 can identify host devices 106 by one or more device identifiers, a unique device identifier (UDID), a media access control (MAC) address, an internet protocol (IP) address, or another identifier that uniquely identifies a device with respect to other devices.

The device data 122 can include an enrollment status indicating whether a computing device, including a DPU device, is enrolled with or managed by the management service 120. For example, an end-user device, an edge device, IoT device, host device 106, client device, or other devices can be designated as “enrolled” and can be permitted to access the enterprise workloads and data hosted by host devices 106, while those designated as “not enrolled,” or having no designation, can be denied access to the enterprise resources. The device data 122 can further include indications of the state of IoT devices, edge devices, end user devices, host device 106, DPU devices 109 and other devices. For example, the device data 122 can indicate that a host device 106 includes a DPU device 109 that has a DPU management operating system 165 installed. This can enable providing remotely-hosted management services to the host device 106 through or using the DPU device 109. This can also include providing management services to other remotely-located client or host devices 106 using resources of the DPU device 109. While a user account 126 can be associated with a particular person as well as client devices, a device account 128 can be unassociated with any particular person, and can nevertheless be utilized for an IoT device, edge device, or another client device that provides automatic functionalities.

Device data 122 can also include data pertaining to user groups. An administrator can specify one or more of the host devices 106 as belonging to a user group. The user group can refer to a group of user accounts 126, which can include device accounts 128. User groups can be created by an administrator of the management service 120.

Compliance rules 124 can include, for example, configurable criteria that must be satisfied for the host devices 106 and other devices to be in compliance with the management service 120. The compliance rules 124 can be based on a number of factors, including geographical location, activation status, enrollment status, and authentication data, including authentication data obtained by a device registration system, time, and date, and network properties, among other factors associated with each device. The compliance rules 124 can also be determined based on a user account 126 associated with a user.

Compliance rules 124 can include predefined constraints that must be met in order for the management service 120, or other applications, to permit host devices 106 and other devices access to enterprise data and other functions of the management service 120. The management service 120 can communicate with management instructions on the client device to determine whether states exist on the client device which do not satisfy one or more of the compliance rules 124. States can include, for example, a virus or malware being detected; installation or execution of a blacklisted application; and/or a device being “rooted” or “jailbroken,” where root access is provided to a user of the device. Additional states can include the presence of particular files, questionable device configurations, vulnerable versions of applications, vulnerable states of the client devices or other vulnerability, as can be appreciated. While the client devices can be discussed as user devices that access or initiate workloads 130 that are executed by the host devices 106, all types of devices discussed herein can also execute virtualization components and provide hardware used to host workloads 130.

The management service 120 can oversee the management and resource scheduling using hardware provided using host devices 106 and DPU devices 109. The management service 120 can oversee the management and resource scheduling of services that are provided to the host devices 106 and DPU devices 109 using remotely located hardware. The management service 120 can transmit various software components, including enterprise workloads, enterprise data, and other enterprise resources for processing and storage using the various host devices 106. The host devices 106 can include host devices 106 such as a server computer or any other system providing computing capability, including those that compose the management system 103. Host devices 106 can include public, private, hybrid cloud and multi-cloud devices that are operated by third parties with respect to the management service 120. The host devices 106 can be located in a single installation or can be distributed among many different geographical locations which can be local and/or remote from the other components.

The host devices 106 can include DPU devices 109 that are connected to the host device 106 through a universal serial bus (USB) connection, a Peripheral Component Interconnect (PCI), PCI Express (PCI-e) or mini-PCI-e connection, or another physical connection. DPU devices 109 can include hardware accelerator devices specialized to perform artificial neural networks, machine vision, machine learning, and other types of special purpose instructions written using CUDA, OpenCL, C++, and other instructions. The DPU devices 109 can utilize in-memory processing, low-precision arithmetic, and other types of techniques. The DPU devices 109 can have hardware including a network interface controller (NIC), CPUs, data storage devices, memory devices, and accelerator devices.

The management service 120 can include a scheduling service that monitors resource usage of the host devices 106, and particularly the host devices 106 that execute enterprise workloads 130. The management service 120 can also track resource usage of DPU devices 109 that are installed on the host devices 106. The management service 120 can track the resource usage of DPU devices 109 in association with the host devices 106 to which they are installed. The management service 120 can also track the resource usage of DPU devices 109 separately from the host devices 106 to which they are installed.

In some examples, the DPU devices 109 can execute workloads 130 assigned to execute on host devices 106 to which they are installed. For example, the host management operating system 155 can communicate with a DPU management operating system 165 to offload all or a subset of a particular workload 130 to be performed using the hardware resources of a DPU device 109. Alternatively, the DPU devices 109 can execute workloads 130 assigned, by the management service 120, specifically to the DPU device 109 or to a virtual device that includes the hardware resources of a DPU device 109. In some examples, the management service 120 can communicate directly with the DPU management operating system 165, and in other examples the management service 120 can use the host management operating system 155 to communicate with the DPU management operating system 165. The management service 120 can use DPU devices 109 to provide the host device 106 with access to workloads 130 executed using the hardware resources of another host device 106 or DPU device 109.

The host device 106 is shown to have software including a DPU maintenance process 152, a host management operating system 155, and hardware including a baseboard management controller (BMC) 159 as well as its compute, memory, data storage, network, interconnect, and other hardware components. The DPU device 109 can have software include a DPU management operating system 165 and hardware as discussed.

The DPU maintenance process 152 can be a DPU component installer executed by the host device 106 to perform an installation of a software, firmware, or other executable instruction set on the DPU device 106. The DPU maintenance process 152 can be a host shutdown process that includes host-DPU coordination instructions executed by the host device 106 to coordinate with the DPU device 106 for host shutdowns. The DPU maintenance process 152 can be a DPU reboot process that includes host-DPU coordination instructions executed by the host device 106 to coordinate reboots of the DPU device 106. The DPU maintenance process 152 can be provided to the host device 106 using a command from the management service 120, downloaded from a network location, or from a USB or other removable media device connected to the host device 106.

The host management operating system 155 can include a bare metal or type 1 hypervisor that can provide access to the physical memory, physical processors, physical data storage, and physical network resources of the host devices 106 to perform workloads 130. A host management operating system 155 can create, configure, reconfigure, and remove virtual machines and other virtual devices on a host device 106. The host management operating system 155 can also relay instructions from the management service 120 to the DPU management operating system 165. In other cases, the management service 120 can communicate with the DPU management operating system 165 directly. The host management operating system 155 can identify that a workload 130 or a portion of a workload 130 includes instructions that can be executed using the DPU device 109, and can offload these instructions to the DPU device 109.

The BMC 159 can include a specialized processor, chip, system-on-chip, or other hardware devices used for “remote” monitoring and management of the host device 106. The BMC 159 can be part of the motherboard or baseboard of the host device 106. In some examples, the BMC 159 can have a separate power supply that can enable the BMC 159 to remain operational even if the host device 106 is power cycled. The BMC 159 can be accessed using a network connection. The BMC 159 can access the installer server component using this network connection, although the BMC 159 can be considered part of the same host device 106 by being located on the motherboard.

The BMC 159 can include the ability to power off, power on, and otherwise power cycle the host device 106. The BMC 159 can include or use sensors to identify hardware and software configurations of the host device 106. For example, the BMC 159 can identify a list of all the DPU devices 109 installed to the host device 106. The BMC 159 can also include the ability to transmit commands to the host device 106 using BMC-to-Host interfaces such as network controller sideband interface (NC-SI), General Purpose Input/Output (GPIO), Serial Peripheral Interface (SPI), Inter-Integrated Circuit (I2C or IIC), synchronous or asynchronous serial busses, and others. The BMC 159 can also include the ability to transmit commands to the DPU device 109 using BMC-to-DPU interfaces such as network controller sideband interface (NC-SI), General Purpose Input/Output (GPIO), Serial Peripheral Interface (SPI), Inter-Integrated Circuit (I2C or IIC), synchronous or asynchronous serial busses, and others.

The DPU management operating system 165 can be a management-service-specific operating system that enables the management service 120 to manage the DPU device 109 and assign workloads 130 to execute using its resources. The DPU management operating system 165 can communicate with the host management operating system 155 and/or with the management service 120 directly to provide access to the physical memory, physical processors, physical data storage, physical network resources, and physical accelerator resources of the DPU devices 109. However, the DPU management operating system 165, or an up-to-date version of the DPU management operating system 165 may not be initially installed to the DPU device 109. In some cases, since the DPU devices 109 can vary in form and function, DPU management operating system 165 can be DPU-device-type specific for a device type such as a manufacturer, product line, or model type of a DPU device 109.

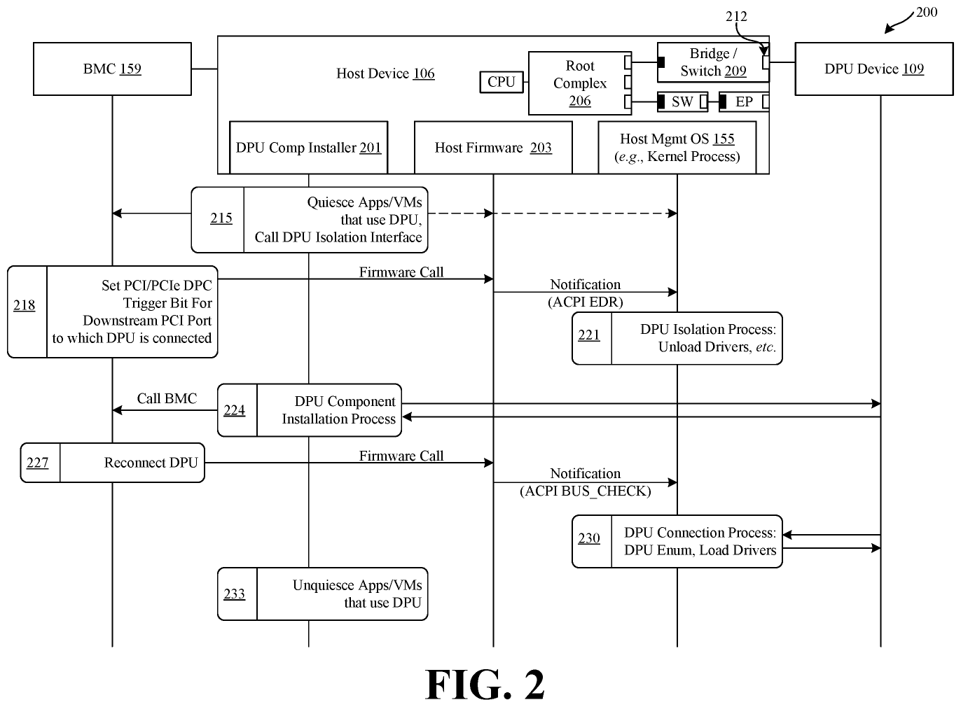

FIG. 2 shows a sequence diagram 200 that provides an example of the operation of components of the networked environment 100 for host-DPU coordination for DPU maintenance events. While a particular step can be discussed as being performed by a particular hardware or software component of the networked environment 100, other components can perform aspects of that step. Generally, this figure shows how the components work in concert to install, to the DPU device 109, new or updated firmware, software, or other components that include executable instructions.

The figure also shows some additional hardware and software components of the host device 106. In this example, the host device 106 is shown to have software components including the DPU component installer 201, host firmware 203, and the host management operating system 155, among other software components that are not shown. The host device 106 is shown to have a CPU connected to a root complex 206.

The root complex 206 can be an interconnect device of the host device 106, and can correspond to a PCI, PCI-e, or other PCI-type root complex. The root complex 206 in this case has a number of downstream ports to the other PCI-type devices such as bridges, switches, and endpoint devices including the DPU device 109. The downstream ports are represented as white rectangles, while upstream ports are represented as grey rectangles. The PCI-type devices can include a bridge or switch 209 as well as others. The DPU device 109 can be connected to a downstream port associated with the root complex 206. This can include a downstream port of the root complex 206 itself or a downstream port of the bridge or switch 209 that is connected through a hierarchy of interconnects. The downstream port 212 can refer to the specific or particular downstream PCI or PCIe port to which the DPU device 109 is connected. The terms PCI and PCIe when used individually such as in a term referencing a “PCI” or “PCIe” hardware or software component, can be considered inclusive of either PCI and/or PCIe to the extent that functionalities overlap.

Moving to the various host-DPU coordination steps shown, in step 215, the DPU component installer 201 can quiesce applications and virtual devices that use the DPU device 109. Various applications and virtual devices (virtual machines, containers, pods, etc.) that are executed using the host device 106 can utilize or call functions of the DPU device 109. The DPU component installer 201 can identify these applications and virtual machines in order to prevent them from attempting to access the DPU device 109, since this can cause a host panic. The host panic can refer to a detected error state of the host management operating system 155, or any other application or virtual device that is executed using the host device 106. The host panic can additionally or alternatively refer to the hardware or software functionalities triggered in response to the detected error state, such as a panic function executed on the host device 106.

The DPU component installer 201 can identify applications and virtual devices that use the DPU device 109 by querying a management component or accessing management data stored on the host device 106 or the management system 103. The host management operating system, the management service 120, or another executable component can maintain a record of all applications and virtual devices that use the DPU device 109, or the applications and virtual devices themselves can provide or store this information.

The DPU component installer 201 can then quiesce the applications and virtual devices that use the DPU device 109. This can include making a call or otherwise instructing a component of the host device 106 such as the host firmware 203, host management operating system 155, or the applications and virtual devices directly. Quiescing can refer to placing the applications and virtual devices in a paused state, a suspended state, or a halted state. Notably, the DPU component installer 201 can leave other applications that do not use the DPU device 109 executing, since the maintenance event for the DPU device 109 does not affect their operation and does not cause a panic or error.

Pausing or suspending an application or virtual device stops it in its current state. The process can include creating a snapshot or suspended state file or file set that preserves the current state and stopping the application or virtual device. When the paused (or suspended) application or virtual device is resumed, the state is exactly the same as when it was paused. In some examples, the DPU component installer 201 can halt or power off the application or virtual device. Generally, this can refer to stopping execution of the application or virtual device without saving its state. This can be done if the application or virtual device state is not a priority for that particular application or virtual device, or if resources are unavailable for the snapshot or suspended state record. Once the applications and virtual devices that use the DPU device 109 are quiesced, the DPU component installer 201 can call a DPU isolation interface exposed by the BMC 159. Alternatively, the DPU component installer 201 can call a DPU isolation interface exposed by the DPU management operating system 155 or the host firmware 203. In the alternative scenario, the steps here described as performed be the BMC 159 can be performed by the component that provides the DPU isolation interface. Since the component calling the DPU isolation interface can be a user space application, the DPU isolation interface can be exposed to user space applications of the host device 106.

In step 218, the BMC 159 can receive the call to its DPU isolation interface. The DPU isolation interface can be an interface provided by the BMC 159 that sets a PCIe DPC soft trigger bit for the downstream port 212 to which the DPU device 109 is connected. The BMC 159 can identify a particular DPU device 109, for example, one specified in the call. The BMC 159 can then identify the downstream port 212 to which the specified DPU device 109 is connected. The BMC 159 can set the trigger bit for the particular downstream port 212. This can include making a firmware call to the host firmware 203. The host firmware 203 can set the trigger bit.

The downstream port 212 hardware can set encoding “0x3” or other appropriate code in a trigger reason field and “0x1” in a trigger reason extension field of a Downstream Port Containment (DPC) status register to indicate that DPC is caused by software trigger method. Once the trigger bit is set, this can suppress uncorrectable errors and prevent host panic. The host firmware 203 and/or the BMC 159 can also transmit a notification to the host management operating system 155 such as an Advanced Configuration and Power Interface (ACPI) Endpoint Detection and Response (EDR) notification.

In step 221, the host management operating system 155, for example, its kernel component or another component, can perform its DPU isolation process. This can include or invoking a kernel PCI(e) DPC module of the host management operating system 155. This can cause an ACPI EDR notification handler to identify the port that experienced DPC by calling ACPI PCI_DSM index 0xD. The process can read the reason fields of the downstream port 212 DPC status register to identify that the DPC is triggered by the PCIe DPC software trigger bit.

The host management operating system 155 kernel PCIe DPC module or other component can then transmit a “DEVICE_HOTPLUG_EVENT_YANKED” request to a device layer for the downstream port 212. The device layer can be provided or accessed using a component of the host management operating system 155, such as a device manager. The host management operating system 155 device manager can unload drivers for the DPU device 109 from the host device 106 and removes the DPU device 109 under the downstream port 212 from host management operating system 155 device manager. The DPU device 109 can also be removed from host management operating system 155 PCIe layer. The host management operating system 155 kernel PCIe DPC module can call an ACPI_OST method on the device for which EDR is notified with a failure status such as 0x81 as status code.

In step 224, the DPU component installer 201 can then proceed with installation steps of the installation package. This can install or update DPU firmware, DPU operating system, or other DPU executables. The installation can include one or more reboots of the DPU device 109. Since the software trigger bit is set for the downstream port 212 to which the DPU device 109 is connected, all of the PCI events are suppressed from the host management operating system 155 and host device 106 generally. Once installation is complete, DPU component installer 201 can notify or make a call to the BMC 159, such as a DPU reconnection call.

In step 227, the BMC 159 can initiate a DPU reconnection process. For example, the BMC 159 can make a call to the host firmware 203 that causes the host firmware 203 to place the DPU device 109 in a power state for device enumeration. The host firmware 203 can perform this action and send a notification such as an ACPI BUS_CHECK notification to the host management operating system 155.

Alternatively, the DPU component installer 201 can call a DPU reconnection interface exposed by the DPU management operating system 155 or the host firmware 203. In the alternative scenario, the steps here described as performed be the BMC 159 can be performed by the component that provides the DPU isolation interface.

In step 230, host management operating system 155 can perform a DPU connection or reconnection process. For example, the management operating system 155 kernel ACPI hot plug module can implement a BUS_CHECK handler that re-enumerates and sends a device hot plug request such as ‘DEVICE_HOTPLUG_EVENT_INSERT’ to the host management operating system 155 device manager. The host management operating system 155 device manager can load the drivers for the DPU device 109 that is identified at the downstream port 212.

In step 233, the DPU component installer 201 can unquiesce the applications and virtual devices. This can refer to unpausing, resuming, or re-launching applications and virtual devices that were quiesced.

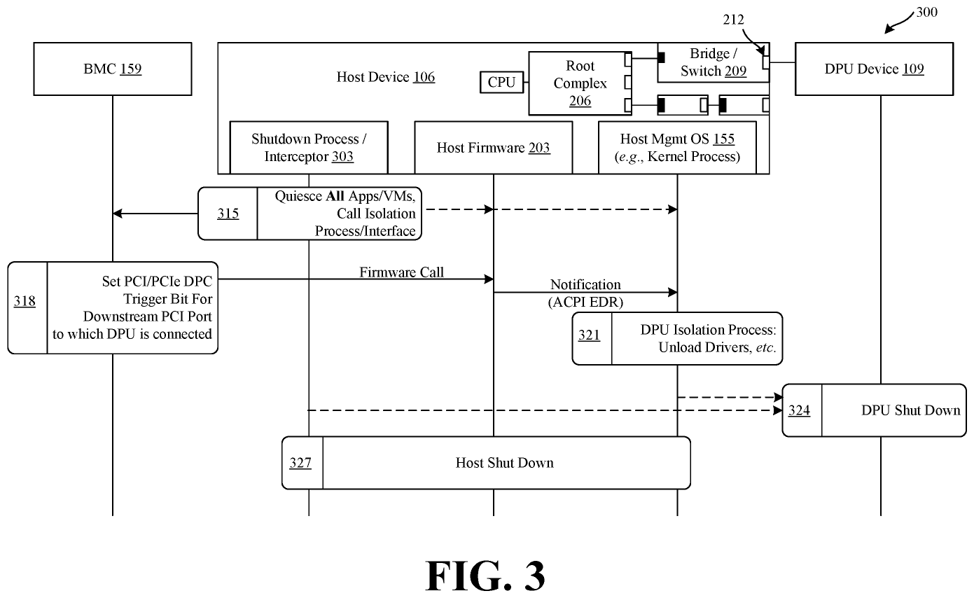

FIG. 3 shows a sequence diagram 200 that provides an example of the operation of components of the networked environment 100 for host-DPU coordination for DPU maintenance events. While a particular step can be discussed as being performed by a particular hardware or software component of the networked environment 100, other components can perform aspects of that step. Generally, this figure shows how the components work in concert to coordinate a host shutdown between the host device 106 and the DPU device 109.

In this example, the host device 106 is shown to have software components including the host shutdown process 303, the host firmware 203, and the host management operating system 155, among other software components that are not shown. The host device 106 is shown to have a CPU connected to a root complex 206.

The root complex 206 has a number of downstream ports to the other PCI-type devices such as bridges, switches, and endpoint devices including the DPU device 109. In some examples, multiple DPU device 109 can be connected to multiple downstream ports. The downstream ports are represented as white rectangles, while upstream ports are represented as grey rectangles. The PCI-type devices can include a bridge or switch 209 as well as others. The DPU device 109 can be connected to a downstream port associated with the root complex 206. This can include a downstream port of the root complex 206 itself or a downstream port of the bridge or switch 209 that is connected through a hierarchy of interconnects. The downstream port 212 can refer to the specific or particular downstream port to which the DPU device 109 is connected.

The shutdown process 303 can refer to a shutdown (or reboot) process of the host management operating system 155, or a shutdown (or reboot) interceptor that intercepts a shut down command or request to an operating system such as the host management operating system 155, or to another operating system such as WINDOWS®, LINUX®, APPLE®, and others that can execute in addition to the host management operating system 155. In any case, the shutdown process 303 can refer to any process that involves a shutdown of the host device 106, such as a power cycle command, a reboot command, a power off command, and so on. If the shutdown process 303 is an interceptor type process, it can identify a user initiated or software initiated shutdown command. The software initiated shutdown command can include a command received from the management service 120. The shutdown process 303 can perform its actions that guide DPU device 109 shut down prior to allowing the shutdown to proceed.

Moving to the various host-DPU coordination steps shown, in step 315, the DPU maintenance process 152 can quiesce all applications and virtual devices on the host device 106. This can include making a call or otherwise instructing a component of the host device 106 such as the host firmware 203, host management operating system 155, or the applications and virtual devices directly. Quiescing can refer to placing the applications and virtual devices in a paused state, a suspended state, or a halted state.

Once the applications and virtual devices that use the DPU device 109 are quiesced, the DPU maintenance process 152 can call a DPU isolation interface exposed by the BMC 159. Alternatively, the DPU maintenance process 152 can call a DPU isolation interface exposed by the DPU management operating system 155 or the host firmware 203. In the alternative scenario, the steps here described as performed be the BMC 159 can be performed by the component that provides the DPU isolation interface.

In step 318, the BMC 159 can receive the call to its DPU isolation interface. The DPU isolation interface can be an interface provided by the BMC 159 that sets a PCIe DPC soft trigger bit for the downstream port 212 to which the DPU device 109 is connected. The BMC 159 can identify a particular DPU device 109, for example, one specified in the call. The BMC 159 can then identify the downstream port 212 to which the specified DPU device 109 is connected. The BMC 159 can set the trigger bit for the particular downstream port 212. This can include making a firmware call to the host firmware 203. The host firmware 203 can set the trigger bit.

The downstream port 212 hardware can set encoding “0x3” or other appropriate code in a trigger reason field and “0x1” in a trigger reason extension field of a Downstream Port Containment (DPC) status register to indicate that DPC is caused by software trigger method. Once the trigger bit is set, this can suppress uncorrectable errors and prevent host panic. The host firmware 203 and/or the BMC 159 can also transmit a notification to the host management operating system 155 such as an Advanced Configuration and Power Interface (ACPI) Endpoint Detection and Response (EDR) notification.

In step 321, the host management operating system 155, for example, its kernel component or another component, can perform its DPU isolation process. This can include or invoking a kernel PCI(e) DPC module of the host management operating system 155. This can cause an ACPI EDR notification handler to identify the port that experienced DPC by calling ACPI PCI_DSM index 0xD. The process can read the reason fields of the downstream port 212 DPC status register to identify that the DPC is triggered by the software trigger bit.

The host management operating system 155 kernel PCIe DPC module or other component can then transmit a “DEVICE_HOTPLUG_EVENT_YANKED” request to a device layer for the downstream port 212. The device layer can be provided or accessed using a component of the host management operating system 155, such as a device manager. The host management operating system 155 device manager can unload drivers for the DPU device 109 and removes the device under the downstream port 212 from host management operating system 155 device manager. The DPU device 109 can also be removed from host management operating system 155 PCIe layer. The host management operating system 155 kernel PCIe DPC module can call an ACPI_OST method on the device for which EDR is notified with a failure status such as 0x81 as status code.

In step 324, the DPU device 109 can perform a shut down operation. In some examples, the shutdown process 303 can transmit a command for the DPU device 109 to shut down, and can perform a waiting operation until a response is received or until the shutdown process 303 detects that the DPU device 109 has been shut down.

In step 327, the shutdown process 303 and other components such as the host firmware 203, the host management operating system 155, and potentially other operating systems of the host device 106 can work in concert to perform a shutdown of the host device 106. In some examples, the shutdown process 303 can identify that the DPU shutdown is completed and can pass control of the shutdown back to the software component that the shutdown process 303 intercepted as it started a host shutdown according to a user or software command.

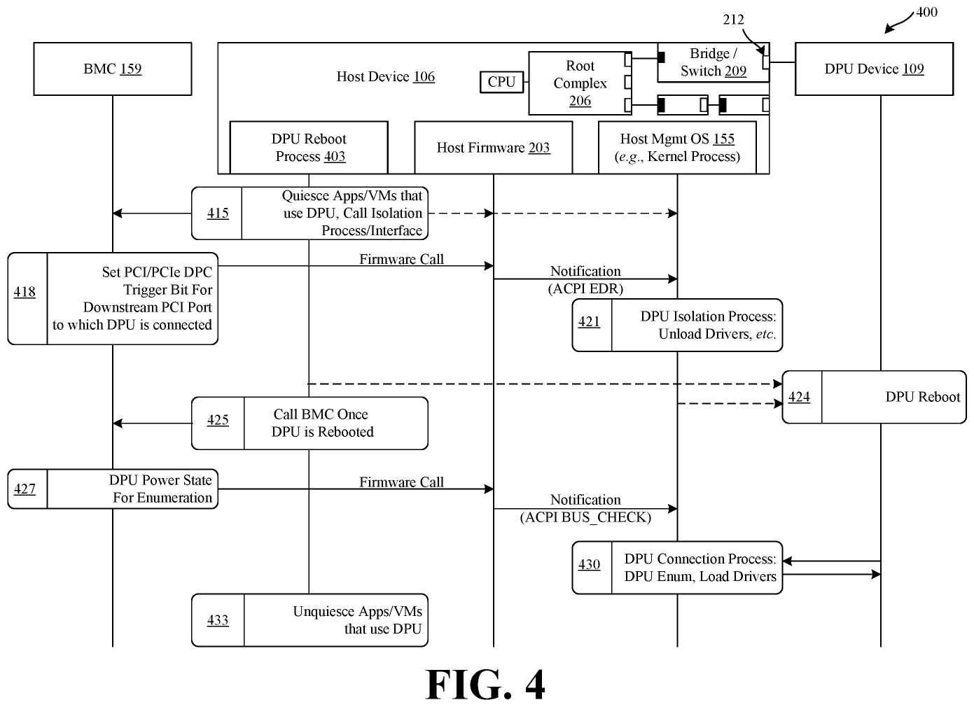

FIG. 4 shows a sequence diagram 400 that provides an example of the operation of components of the networked environment 100 for host-DPU coordination for DPU maintenance events. While a particular step can be discussed as being performed by a particular hardware or software component of the networked environment 100, other components can perform aspects of that step. Generally, this figure shows how the components work in concert to perform DPU-Host coordination for a maintenance reboot of the DPU device 109.

The host device 106 is shown to have software components including a DPU reboot process 403, host firmware 203, and the host management operating system 155, among other software components that are not shown. The host device 106 is shown to have a CPU connected to a root complex 206. The DPU reboot process 403 can include a component of the host management operating system 155 or another management component executed using the host device 106.

The root complex 206 has a number of downstream ports to the other PCI-type devices such as bridges, switches, and endpoint devices including the DPU device 109. In some examples, multiple DPU device 109 can be connected to multiple downstream ports. The downstream ports are represented as white rectangles, while upstream ports are represented as grey rectangles. The PCI-type devices can include a bridge or switch 209 as well as others. The DPU device 109 can be connected to a downstream port associated with the root complex 206. This can include a downstream port of the root complex 206 itself or a downstream port of the bridge or switch 209 that is connected through a hierarchy of interconnects. The downstream port 212 can refer to the specific or particular downstream port to which the DPU device 109 is connected.

Moving to the various host-DPU coordination steps shown, in step 415, the DPU reboot process 403 can quiesce applications and virtual devices that use the DPU device 109. Various applications and virtual devices (virtual machines, containers, pods, etc.) that are executed using the host device 106 can utilize or call functions of the DPU device 109. The DPU reboot process 403 can identify these applications and virtual machines in order to prevent them from attempting to access the DPU device 109, since this can cause a host panic. The host panic can refer to a detected error state of the host management operating system 155, or any other application or virtual device that is executed using the host device 106.

The DPU reboot process 403 can identify applications and virtual devices that use the DPU device 109 by querying a management component or accessing management data stored on the host device 106 or the management system 103. The host management operating system, the management service 120, or another executable component can maintain a record of all applications and virtual devices that use the DPU device 109, or the applications and virtual devices themselves can provide or store this information.

The DPU reboot process 403 can then quiesce the applications and virtual devices that use the DPU device 109. This can include making a call or otherwise instructing a component of the host device 106 such as the host firmware 203, host management operating system 155, or the applications and virtual devices directly. Quiescing can refer to placing the applications and virtual devices in a paused state, a suspended state, or a halted state. Notably, the DPU reboot process 403 can leave other applications that do not use the DPU device 109 executing, since the maintenance event for the DPU device 109 does not affect their operation and does not cause a panic or error.

Once the applications and virtual devices that use the DPU device 109 are quiesced, the DPU reboot process 403 can call a DPU isolation interface exposed by the BMC 159. Alternatively, the DPU reboot process 403 can call a DPU isolation interface exposed by the DPU management operating system 155 or the host firmware 203. In the alternative scenario, the steps here described as performed be the BMC 159 can be performed by the component that provides the DPU isolation interface.

In step 418, the BMC 159 can receive the call to its DPU isolation interface. The DPU isolation interface can be an interface provided by the BMC 159 that sets a PCIe DPC soft trigger bit for the downstream port 212 to which the DPU device 109 is connected. The BMC 159 can identify a particular DPU device 109, for example, one specified in the call. The BMC 159 can then identify the downstream port 212 to which the specified DPU device 109 is connected. The BMC 159 can set the trigger bit for the particular downstream port 212. This can include making a firmware call to the host firmware 203. The host firmware 203 can set the trigger bit.

The downstream port 212 hardware can set encoding “0x3” or other appropriate code in a trigger reason field and “0x1” in a trigger reason extension field of a Downstream Port Containment (DPC) status register to indicate that DPC is caused by software trigger method. Once the trigger bit is set, this can suppress uncorrectable errors and prevent host panic. The host firmware 203 and/or the BMC 159 can also transmit a notification to the host management operating system 155 such as an Advanced Configuration and Power Interface (ACPI) Endpoint Detection and Response (EDR) notification.

In step 421, the host management operating system 155, for example, its kernel component or another component, can perform its DPU isolation process. This can include or invoking a kernel PCI(e) DPC module of the host management operating system 155. This can cause an ACPI EDR notification handler to identify the port that experienced DPC by calling ACPI PCI_DSM index 0xD. The process can read the reason fields of the downstream port 212 DPC status register to identify that the DPC is triggered by the software trigger bit.

The host management operating system 155 kernel PCIe DPC module or other component can then transmit a “DEVICE_HOTPLUG_EVENT_YANKED” request to a device layer for the downstream port 212. The device layer can be provided or accessed using a component of the host management operating system 155, such as a device manager. The host management operating system 155 device manager can unload drivers for the DPU device 109 and removes the device under the downstream port 212 from host management operating system 155 device manager. The DPU device 109 can also be removed from host management operating system 155 PCIe layer. The host management operating system 155 kernel PCIe DPC module can call an ACPI_OST method on the device for which EDR is notified with a failure status such as 0x81 as status code.

In step 424, the DPU device 109 can perform a reboot operation. In some examples, the DPU reboot process 403 can transmit a command for the DPU device 109 to reboot, and can perform a waiting operation until a response is received or until the DPU reboot process 403 detects that the DPU device 109 has been rebooted successfully.

In step 425, the DPU reboot process 403 can call the BMC 159 to set the DPU power state for enumeration. This can include a DPU reconnection call or another type of call to the BMC 159.

In step 427, the BMC 159 can initiate a DPU reconnection process. For example, the BMC 159 can make a call to the host firmware 203 that causes the host firmware 203 to place the DPU device 109 in a power state for device enumeration. The host firmware 203 can perform this action and send a notification such as an ACPI BUS_CHECK notification to the host management operating system 155.

Alternatively, the DPU reboot process 403 can call a DPU reconnection interface exposed by the DPU management operating system 155 or the host firmware 203. In the alternative scenario, the steps here described as performed be the BMC 159 can be performed by the component that provides the DPU isolation interface.

In step 430, host management operating system 155 can perform a DPU connection or reconnection process. For example, the management operating system 155 kernel ACPI hot plug module can implement a BUS_CHECK handler that re-enumerates and sends a device hot plug request such as ‘DEVICE_HOTPLUG_EVENT_INSERT’ to the host management operating system 155 device manager. The host management operating system 155 device manager can load the drivers for the DPU device 109 that is identified at the downstream port 212.

In step 433, the DPU reboot process 403 can unquiesce the applications and virtual devices. This can refer to unpausing, resuming, or re-launching applications and virtual devices that were quiesced.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory devices can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although the various services and functions described herein can be embodied in software or code executed by general purpose hardware as discussed above, as an alternative, the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagrams and flowcharts can show examples of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or another system. The machine code can be converted from the source code. If embodied in hardware, each block can represent a circuit or a number of interconnected circuits to implement the specified logical function(s).

Although sequence diagrams and flowcharts can be shown in a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted.

Also, any logic or application described herein that includes software or code can be embodied in any non-transitory computer-readable medium for use by or in connection with an instruction execution system such as a processor in a computer system or another system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described embodiments of the present disclosure are merely possible examples of implementations described for a clear understanding of the principles of the disclosure. Many variations and modifications can be made to the above-described embodiments without departing substantially from the spirit and principles of the disclosure. All such modifications and variations are intended to be included in the following claims herein, within the scope of this disclosure.

Therefore, the following is claimed:

1. A non-transitory computer-readable medium comprising instructions, wherein the instructions, when executed by at least one processor, cause at least one computing device to at least:
quiesce, by a data processing unit (DPU) maintenance process executed by a host device comprising a connected DPU device, a plurality of applications or virtual machines of the host device;
call, by the DPU maintenance process, a DPU isolation interface that isolates the DPU device to prevent host panic;
execute, by a kernel process of the host device, a DPU isolation process that unloads at least one driver of the DPU device and removes, from a device manager of the host device, at least one device of the DPU device; and
perform, by the DPU maintenance process, at least one DPU maintenance action based at least in part on the DPU device being isolated.

2. The non-transitory computer-readable medium of claim 1, wherein the instructions, when executed by the at least one processor, cause the at least one computing device to at least:
unquiesce, by the DPU maintenance process, the plurality of applications or virtual machines.

3. The non-transitory computer-readable medium of claim 1, wherein the DPU isolation interface is provided by a Baseboard Management Controller (BMC) of the host device.

4. The non-transitory computer-readable medium of claim 1, wherein the DPU isolation interface is provided by the kernel process of the host device.

5. The non-transitory computer-readable medium of claim 1, wherein the DPU maintenance process comprises a DPU component installer, and the at least one DPU maintenance action comprises installing or updating a set of executable instructions on the DPU device.

6. The non-transitory computer-readable medium of claim 1, wherein the DPU maintenance process comprises a host shutdown process or a host shutdown interceptor process, and the at least one DPU maintenance action comprises shutting down the DPU device prior to shutting down the host device.

7. The non-transitory computer-readable medium of claim 1, wherein the DPU maintenance process comprises a DPU device reboot process, and the at least one DPU maintenance action comprises rebooting the DPU device.

8. A system, comprising:
at least one computing device comprising at least one processor; and
a data store comprising instructions, wherein the instructions, when executed by the at least one processor, cause the at least one computing device to at least:
quiesce, by a data processing unit (DPU) maintenance process executed by a host device comprising a connected DPU device, a plurality of applications or virtual machines of the host device;
call, by the DPU maintenance process, a DPU isolation interface that isolates the DPU device to prevent host panic;
execute, by a kernel process of the host device, a DPU isolation process that unloads at least one driver of the DPU device and removes, from a device manager of the host device, at least one device of the DPU device; and
perform, by the DPU maintenance process, at least one DPU maintenance action based at least in part on the DPU device being isolated.

9. The system of claim 8, wherein the instructions, when executed by the at least one processor, cause the at least one computing device to at least:
unquiesce, by the DPU maintenance process, the plurality of applications or virtual machines.

10. The system of claim 8, wherein the DPU isolation interface is provided by a Baseboard Management Controller (BMC) of the host device.

11. The system of claim 8, wherein the DPU isolation interface is provided by the kernel process of the host device.

12. The system of claim 8, wherein the DPU maintenance process comprises a DPU component installer, and the at least one DPU maintenance action comprises installing or updating a set of executable instructions on the DPU device.

13. The system of claim 8, wherein the DPU maintenance process comprises a host shutdown process or a host shutdown interceptor process, and the at least one DPU maintenance action comprises shutting down the DPU device prior to shutting down the host device.

14. The system of claim 8, wherein the DPU maintenance process comprises a DPU device reboot process, and the at least one DPU maintenance action comprises rebooting the DPU device.

15. A method, comprising:
quiescing, by a data processing unit (DPU) maintenance process executed by a host device comprising a connected DPU device, a plurality of applications or virtual machines of the host device;
calling, by the DPU maintenance process, a DPU isolation interface that isolates the DPU device to prevent host panic;
executing, by a kernel process of the host device, a DPU isolation process that unloads at least one driver of the DPU device and removes, from a device manager of the host device, at least one device of the DPU device; and
performing, by the DPU maintenance process, at least one DPU maintenance action based at least in part on the DPU device being isolated.

16. The method of claim 15, wherein the instructions, when executed by the at least one processor, cause the at least one computing device to at least:
unquiescing, by the DPU maintenance process, the plurality of applications or virtual machines.

17. The method of claim 15, wherein the DPU isolation interface is provided by a Baseboard Management Controller (BMC) of the host device.

18. The method of claim 15, wherein the DPU isolation interface is provided by the kernel process of the host device.

19. The method of claim 15, wherein the DPU maintenance process comprises a DPU component installer, and the at least one DPU maintenance action comprises installing or updating a set of executable instructions on the DPU device.

20. The method of claim 15, wherein the DPU maintenance process comprises a host shutdown process or a host shutdown interceptor process, and the at least one DPU maintenance action comprises shutting down the DPU device prior to shutting down the host device.
